(19) United States
(12) Patent Application Publication
(10) Pub. No.: US 2005/0259854 A1
(43) Pub. Date: Nov. 24, 2005

(54) Method for detection of abnormalities in three-dimensional imaging data

(75) Inventors: Hidetaka Arimura, Nishi-ku (JP); Qiang Li, Naperville, IL (US); Kunio Doi, Willowbrook, IL (US)

Correspondence Address: OBLON, SPIVAK, MCCLELLAND, MAIER & NEUSTADT, P.C., 1940 DUKE STREET, ALEXANDRIA, VA, 22314, US

(73) Assignee: University of Chicago, Chicago, IL (US)

(21) Appl. No.: 10/849,807

(22) Filed: May 21, 2004

(51) Int. Cl. G06K 9/00; G06K 9/40

(52) U.S. Cl. 382/130; 382/254

(57) ABSTRACT

A method, system, and computer program product for determining existence of an abnormality in a medical image, including (1) obtaining volume image data corresponding to the medical image; (2) filtering the volume image data using an enhancement filter to produce a filtered image in which a predetermined pattern is enhanced; (3) detecting, in the filtered image, a first plurality of abnormality candidates using multiple gray-level thresholding; (4) grouping, based on size and local structures, the first plurality of abnormality candidates into a plurality of abnormality classes; (5) removing false positive candidates from each abnormality class based on class-specific image features to produce a second plurality of abnormality candidates; and (6) applying the at least one abnormality to a classifier and classifying each candidate in the second plurality of abnormality candidates as a false positive candidate or an abnormality.

### STATEMENT REGARDING FEDERALLY SPONSORED RESEARCH

The present invention was made in part with U.S. Government support under USPHS Grant Nos. CA62625 and CA98119. The U.S. Government may have certain rights to this invention.

### BACKGROUND OF THE INVENTION

Field of the Invention

The present invention relates generally to the automated detection of structures and assessment of abnormalities in medical images, and more particularly to methods, systems, and computer program products for the detection of intercranial aneurysm in medical images (such as MRA images) using selective enhancement filters.

The present invention also generally relates to computerized techniques for automated analysis of digital images, for example, as disclosed in one or more of U.S. Pat. Nos. 4,839,807; 4,841,555; 4,851,984; 4,875,165; 4,907,156; 4,918,534; 5,072,384; 5,133,020; 5,150,292; 5,224,177; 5,289,374; 5,319,549; 5,343,390; 5,359,513; 5,452,367; 5,463,548; 5,491,627; 5,537,485; 5,598,481; 5,622,171; 5,638,458; 5,657,362; 5,666,434; 5,673,332; 5,668,888; 5,732,697; 5,740,268; 5,790,690; 5,832,103; 5,873,824; 5,881,124; 5,931,780; 5,974,165; 5,982,915; 5,984,870; 5,987,345; 6,011,862; 6,058,322; 6,067,373; 6,075,878; 6,078,680; 6,088,473; 6,112,112; 6,138,045; 6,141,437; 6,185,320; 6,205,348; 6,240,201; 6,282,305; 6,282,307; 6,317,617; 6,466,689; 6,363,163; 6,442,287; 6,335,980; 6,594,378; 6,470,092; 6,483,934; as well as U.S. patent application Ser. Nos. 08/398,307; 09/759,333; 09/760,854; 09/773,636; 09/816,217; 09/830,562; 09/818,831; 09/860,574; 10/270,674; 09/990,311; 09/990,310; 09/990,377; 10/078,694; 10/079,820; 10/120,420; 10/126,523; 10/301,836; 10/355,147; 10/360,814; 10/366,482; all of which are incorporated herein by reference.

The present invention includes the use of various technologies referenced and described in the above-noted U.S. Patents and Applications, as well as described in the documents identified in the following LIST OF REFERENCES, which are cited throughout the specification by the corresponding reference number in brackets:

### LIST OF REFERENCES

(1) Weir B., Unruptured intracranial aneurysms: a review. J Neurosurg 2002; 96: 3-42.
(2) Wardlaw J M and White P M., The detection and management of unruptured intracranial aneurysms. Brain 2000; 123: 205-221.
(3) Fogelholm R, Hemesniemi J, Vapalahti M., Impact of early surgery on outcome after aneurysm subarachnoid hemorrhage: a population-based study. Stroke 1993; 24: 1649-54.
(4) Hop J W, Rinkel G J, Algra A, van Gijn J., Case-fatality rates and functional outcome after subarachnoid hemorrhage: a systematic review. [Review]. Stroke 1997; 28: 660-4.
(5) Hijdra A, Braakman R, van Gijn J, Vermeulen M, van Crevel H., Aneurysmal subarachnoid hemorrhage: complications and outcome in a hospital population. Stroke 1987; 18: 1061-7.
(6) Sengupta R P, McAllister V L., Subarachnoid hemorrhage. Berlin: Springer-Verlag; 1986.
(7) International Study of Unruptured Intracranial Aneurysms Investigators, “Unruptured intracranial aneurysms—risk of rupture and risks of surgical intervention,” The New England Journal of Medicine 1998; 339: 1725-1733.
(8) Ogawa T, Okudera T, Noguchi K, Sasaki N, Inugami A, Uemura K, Yasui N., Cerebral aneurysms: evaluation with three-dimensional CT angiography. AJNR Am J Neuroradiol 1996; 17: 447-454.
(9) Korogi Y, Takahashi M, Katada K, Ogura Y, Hasuo K, Ochi M, Utsunomiya H, Abe T, Imakita S., Intracranial aneurysms: Detection with three-dimensional CT angiography with volume rendering—comparison with conventional angiographic and surgical findings. Radiology 1999; 211: 497-506.
(10) White P M, Teasdale E M, Wardlaw J M, Easton V., Intracranial aneurysms: CT angiography and MR angiography for detection—prospective blinded comparison in a large patient cohort. Radiology 2001; 219: 739-749.
(11) Preda L, Gaetani P, Rodriguez y Baena R, Di Maggio E M, La Fianza A, Dore R, Fulle I, Solcia M, Cecchini A, Infuso L, Campani R., Spiral C T angiography and surgical corrections in the evaluation of intracranial aneurysms. Eur Radiol 1998; 8: 739-745.
(12) Huston J III, Nichols D A, Luetmer P H, Goodwin J T, Meyer F B, Wiebers D O, Weaver A L., Blinded prospective evaluation of sensitivity of MR angiography to known intracranial aneurysms: importance of aneurysm size. AJNR Am J Neuroradiol 1994; 15: 1607-1614.
(13) Aprile I,. Evaluation of cerebral aneurysms with MR-angiography. Riv Neuroradiol 1996; 9: 541-550.
(14) Korogi Y, Takahashi M, Mabuchi N, Miki H, Fujiwara S, Horikawa Y, Nakagawa T, O'Uchi T, Watabe T, Shiga H, Furuse M., Intracranial aneurysms: Diagnostic accuracy of three-dimensional, Fourier transform, time-o-flight MR angiography. Radiology 1994; 193: 181-186.
(15) Chan H P, Doi K, Galhotra S, Vybomy C J, MacMahon H, Jokich P M., Image feature analysis and computer-aided diagnosis in digital radiography. 1. Automated detection of microcalcifications in mammography. Med Phys 1987; 14: 538-548.
(16) Kupinski M A, Giger M L., Automated seeded lesion segmentation on digital mammograms. IEEE Trans on Medical Imaging 1998; 17: 510-517.
(17) Giger M L, Doi K, MacMahon H., Image feature analysis and computer-aided diagnosis in digital radiography. 3. Automated detection of nodules in peripheral lung fields. Med Phys 1988; 15: 158-166.
(18) Katsuragawa S, Doi K, MacMahon H., Image feature analysis and computer-aided diagnosis in digital radiography. Detection and characterization of interstitial lung disease in digital chest radiographs. Med Phys 1988; 15: 311-319.
(19) Suzuki K, Armato III S G, Li F, Sone S, and Doi K., Massive training artificial neural network (MTANN) for reduction of false positives in computerized detection of lung nodules in low-dose CT. Med Phys 2003; 30: 1602-1617.
(20) Uchiyama, Y, Katsuragawa S, Abe H, Shiraishi J, Li F, Li Q, Zhang C-T, Suzuki K, Doi K., Quantitative computerized analysis of diffuse lung disease in high-resolution computed tomography. Med Phys 2003; 30: 2440-2464.
(21) Chan H P, Vybomy C J, MacMahon H, Metz C E, Doi K, Sickles E A., Digital mammography: ROC studies of the effects of pixel size and unsharp-mask filtering on the detection of subtle microcalcifications. Invest Radiol 1987; 22: 581-589.
(22) Shiraishi J, Abe H, Engelmann R, Aoyama M, MacMahon H, Doi K., Computer-aided diagnosis for distinction between benign and malignant solitary pulmonary nodules in chest radiographs: ROC analysis of radiologists' performance. Radiology 2003; 227: 469-474.
(23) Li Q, Sone S, and Doi K., Selective enhancement filters for nodules, vessels, and airway wall in two- and three-dimensional CT scans. Med Phys 2003; 30: 2040-2051.
(24) Otsu N., A threshold selection method from gray level histograms. IEEE Trans Syst, Man & Cybem 1979; SMC-9: 62-66.
(25) Saito T, Toriwaki J., New algorithms for Euclidean distance transformations of an n-dimensional digitized picture with applications. Pattern Recognition 1994; 27: 1551-1565.
(26) Saito T, Toriwaki J., A sequential thinning algorithm for three dimensional digital pictures using the Euclidean distance transformation. Proc. 9th Scandinavian Conf. Image Analysis, SCIA'95 1995; 507-516.
(27) Johnson R A and Wichern D W., Applied Multivariate Statistical Analysis (Prentice-Hall, Englewood Cliffs, N.J., 1992), Sec. 5.3: 184-188.
(28) Sahiner B, Chan H P, Petrick N, Helvie M A, Goodsitt M M., Computerized characterization of masses on mammograms: The rubber band straightening transform and texture analysis. Med Phys 1998; 24: 516-526.

The contents of each of these references, including the above-mentioned patents and patent applications, are incorporated herein by reference. The techniques disclosed in the patents, patent applications, and other references can be utilized as part of the present invention.

Discussion of the Background

An intracranial aneurysm is a swelling along a blood vessel in a brain, which could cause a subarachnoid hemorrhage (SAH) due to the rupture of the aneurysm [1]. SAH is a serious disorder with high mortality and morbidity [2-6]. Prospective autopsy and angiographic studies indicate that between 3.6% and 6% of the general population have intracranial aneurysms [2]. The rupture rate of asymptomatic aneurysms was estimated to be 1-2% per year [2]. Recently, the International Study of Unruptured Intracranial Aneurysms [7] reported that the cumulative rupture rate of aneurysms smaller than 10 mm in diameter was 0.05% per year in patients with no prior SAH, and 0.5% per year for aneurysms larger than 10 mm and for all aneurysms in patients with previous SAH

The accepted reference standard for identification of intracranial aneurysms is intraarterial digital subtraction angiography (DSA)[8-10], which is invasive, time-consuming, and relatively expensive. During the past decade, there has been considerable interest in the roles of “noninvasive” imaging modalities such as computed tomographic angiography (CTA) and magnetic resonance angiography (MRA) in the detection of intracranial aneurysms [2,8-14]. However, CTA should be considered an invasive examination with higher cost, because the patients are exposed to X-rays together with the injection of a contrast medium. On the other hand, MRA can non-invasively detect unruptured intracranial aneurysms without the use of contrast media, at a performance level comparable to that of CTA [10]. Despite these advantages of MRA, it is difficult and time-consuming for radiologists to find small aneurysms, aneurysms overlapping with adjacent vessels, or aneurysms in unusual locations, on maximum intensity projection (MIP) images of MRA. Korogi et al. [14] reported an observer study for detecting intracranial aneurysms on MIP images with 78 aneurysms (including 60 (77%) less than 5 mm in diameter) obtained from 61 patients for assessment of the accuracy of MRA. As a result, the sensitivity for five observers ranged from 58% to 68% (mean, 63%). White et al. [10] compared the observer performance obtained with CTA and MRA in the detection of 108 intracranial aneurysms from 142 patients (with 72 (66%) less than 5 mm in diameter). According to their results, the highest sensitivity between two observers was 69% with CTA and 52% with MRA. Thus, a computer-aided diagnostic (CAD) scheme would be useful in assisting radiologists in the detection of intracranial aneurysms by use of MRA. During the last two decades, a number of CAD schemes have been developed for detection and classification of various abnormalities such as microcalcifications and masses in mammograms [15,16], pulmonary nodules and interstitial infiltrates in chest radiographs [17,18], and nodules and diffuse lung diseases in CT [19, 20]. The usefulness of these schemes has been demonstrated by carrying out a number of observer performance studies [21,22].

Recently, Li et al. [23] developed three selective enhancement filters based on the eigenvalues of a Hessian matrix with multi-scales for dot, line, and plane that can simultaneously enhance objects of specific shapes (such as dot-like lung nodules) and suppress objects of other shapes (such as line-like vessels). Compared with the existing enhancement filters in computer-aided diagnostic schemes for lung nodule detection, the dot-enhancement filter would be useful for improving the sensitivity of lung nodule detection and for reducing the number of false positives at the initial detection step.

### SUMMARY OF THE INVENTION

Accordingly, one object of the present invention is to provide a method for determining existence of at least one abnormality in at least one medical image. In particular, one object of the present invention is to provide an automated computerized scheme for detection of intracranial aneurysms in MRA images. One embodiment of the present invention is based on the use of a three-dimensional (3 D) selective enhancement filter [23] for dots, which correspond to aneurysms. Further, aneurysm candidates and false positives are distinguished by the analysis of localized image features and by the use of rules based on candidate size and local structures.

Accordingly, there is provided a method, system, and computer program product for determining existence of an abnormality in a medical image, including: (1) obtaining volume image data corresponding to the medical image; (2) filtering the volume image data using an enhancement filter to produce a filtered image in which a predetermined pattern is enhanced; (2) detecting, in the filtered image, a first plurality of abnormality candidates using multiple gray-level thresholding; (3) grouping, based on size and local structures, the first plurality of abnormality candidates into a plurality of abnormality classes; (4) removing false positive candidates from each abnormality class based on class-specific image features to produce a second plurality of abnormality candidates; and (5) applying the at least one abnormality to a classifier and classifying each candidate in the second plurality of abnormality candidates as a false positive candidate or an abnormality.

In one embodiment of the present invention, the obtaining step comprises obtaining three-dimensional magnetic resonance angiography (MRA) volume image data.

In another embodiment of the present invention, the obtaining step comprises: (1) obtaining a plurality of axial MRA images; and (2) processing the plurality of axial MRA images to obtain the volume image data, wherein the processing includes at least one of interpolation and cropping of said plurality of axial MRA images; and the volume image data is isotropic.

In another embodiment of the present invention, the filtering step comprises using a dot enhancement filter to produce a filtered image in which dot-like objects are enhanced.

In another embodiment of the present invention, the method, system, and computer program product for detecting at least one abnormality in a medical image further includes identifying, in the filtered image, a search region corresponding to anatomy associated with the at least one abnormality, wherein the detecting step includes detecting the first plurality of abnormality candidates in the search region.

In another embodiment of the present invention, the identifying step includes: (1) segmenting major vessels in said filtered image; and (2) dilating the segmented major vessels in said filtered image using a morphological filter having a circular kernel.

In another embodiment of the present invention, the identifying step includes identifying the search region to include a blood vessel associated with aneurysms.

In another embodiment of the present invention, the detecting step includes: (1) forming a pixel-value histogram in a search area of the filtered image; (2) selecting a threshold value based on the pixel-value histogram; (2) identifying islands in the filtered image having pixel values greater than the selected threshold; (3) determining an effective diameter of each island; (4) selecting islands having an effective diameter greater than a predetermined diameter to be in the first plurality of abnormality candidates; and (5) segmenting each of the first plurality of abnormality candidates by performing region-growing based on at least one image feature.

In another embodiment of the present invention, the grouping step includes: (1) calculating an effective diameter of each of the first plurality of abnormality candidates; and (2) grouping the first plurality of abnormality candidates into a large abnormality class and a small abnormality class based on the calculated effective diameter of each of the first plurality of abnormality candidate.

In another embodiment of the present invention, the removing step comprises: (1) calculating the class-specific image features for each abnormality in each of the plurality of abnormality classes; and (2) removing the false positive candidates from each abnormality class based on the calculated class-specific image features.

In another embodiment of the present invention, the class-specific image features include at least one of average voxel value, a relative standard deviation in voxel value, a relative contrast, an average contrast, effective diameter, sphericity, a relative standard deviation of a distance between a centroid and a surface, and a maximum and minimum distance between the centroid and the surface.

In another embodiment of the present invention, the step of applying and classifying is performed by: (1) calculating at least one feature value of each candidate in the second plurality of abnormality candidates; and (2) applying the at least one feature value to a classifier performing linear discriminant analysis on the calculated at least one feature value.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, in which like reference numerals refer to identical or corresponding parts throughout the several views, and in which:

FIG. 1 illustrates a distribution of diameters of 36 unruptured aneurysms in MRA images;

FIG. 2 illustrates a distribution of 36 aneurysms at various locations, including internal carotid artery (ICA) and middle cerebral artery (MCA), anterior communicating artery (ACoA), basilar artery (BA), anterior cerebral artery (ACA), posterior cerebral artery (PCA), and vertebral artery (VA);

FIG. 3 illustrates a method for the automated detection of abnormalities such as aneurysms in 3 D MRA images according to an embodiment of the present invention;

FIG. 4 is an illustration of (a) an original MRA image and three images selectively enhanced for (b) dot, (c) line, and (d) plane objects, all of which were produced by MIP image processing, wherein an arrow indicates a large (7.5 mm) aneurysm;

FIG. 5 is an illustration of (a) an original image; (b) segmented major vessels; (c) search area for initial candidates; (d) dot-enhanced image; (e) search area in dot-enhanced image; and (f) search area in original image, in which all of the images were produced by MIP image processing;

FIGS. 6A and 6B shows the dependence of the image features on % gray level concerning sphericity and effective diameter (6A); and average voxel values in the inside and outside regions and the average contrast (6B), in which the transition points (dotted line) were defined at the % gray level for a large change in image features;

FIG. 7 is an illustration of core and rind regions in the candidate region, where the core region was defined by a 2-mm sphere at the centroid, and the rind region was defined by a 1-mm thick region inside the surface of the candidate region;

FIG. 8 shows the relationship between the average voxel values in the core and rind regions for small and large aneurysms;

FIG. 9 is a schematic diagram for classification of small candidates into three groups including short-branch type, single-vessel type, and bifurcation type based on the skeleton image;

FIG. 10 is an illustration of a method for searching for a short branch adjacent to the original candidate region in the skeleton image;

FIG. 11 illustrates results obtained with the segmentation of (a) small and (b) large aneurysms by use of the region-growing technique on the dot-enhanced or original images;

FIG. 12 illustrates a relationship between the relative contrast in the original image and the relative contrast in the dot-enhanced images for small and large aneurysms as well as small and large false positives;

FIG. 13 illustrates a relationship between the sphericity and the relative SD of the distance between the centroid and the surface for small and large aneurysms as well as small and large false positives in the dot-enhanced image;

FIG. 14 illustrates a relationship between the effective diameter in the dot-enhanced image and the relative SD of the voxel value in the original image for small and large aneurysms as well as small and large false positives in the dot-enhanced image;

FIG. 15 illustrates a relationship between the effective diameter and the protrusion length in the original image, for short-branch-type candidates;

FIG. 16 shows a relationship between the maximum distance value in the candidate region and average distance value in the outside region, for single-vessel-type candidates;

FIG. 17 shows a relationship between the effective diameter in the dot-enhanced image and the relative SD of the distance between the centroid and the surface, for bifurcation-type candidates;

FIG. 18 shows an FROC curve for overall performance of an embodiment of the present invention in automated detection of intracranial aneurysms in MRA images; and

FIG. 19 illustrates a system for detecting an abnormality in three-dimensional medical images according to an embodiment of the present invention.

### DETAILED DESCRIPTION OF THE PREFERRED EMBODIMENTS

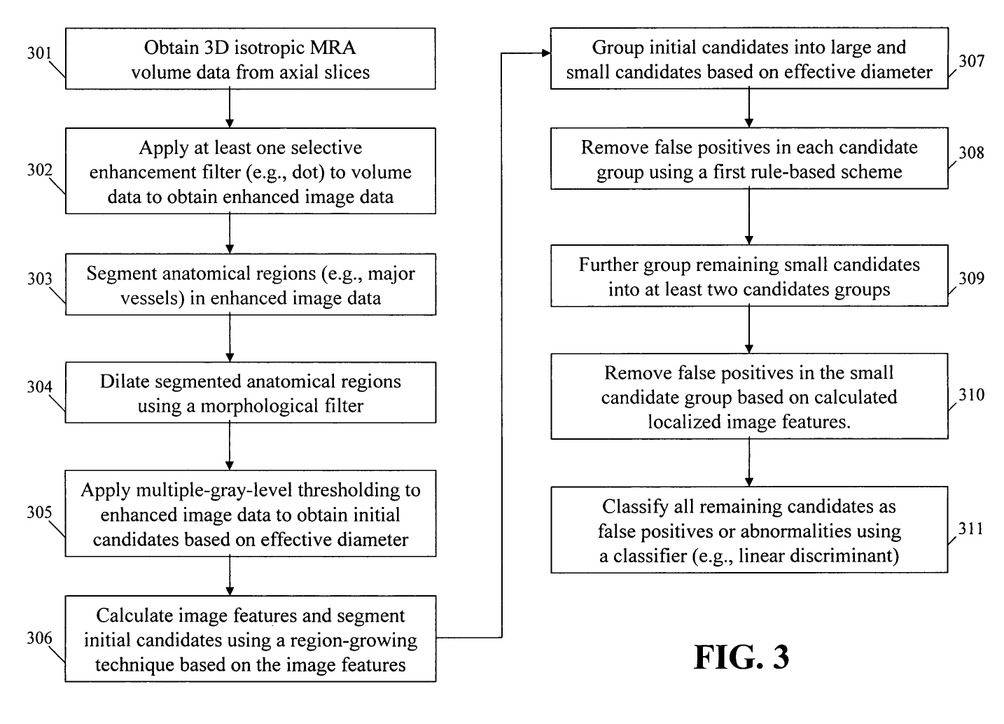

FIG. 3 shows a method for the detection of abnormalities in medical images according to an embodiment of the present invention.

In step 301, three-dimensional isotropic volume data is obtained from a plurality of axial MRA images. For example, each axial image could be 512×512 pixels with a pixel size of 0.391 mm and 128 slices having a slice thickness of 0.5 mm. Then, all original 3 D MRA images would be converted to isotropic volume data by use of linear interpolation and/or cropping such that the volume data was 400×400×128 voxels with a voxel size of 0.5 mm.

In step 302, at least one selective enhancement filter is applied to the isotropic volume data to enhance objects having specific shapes. For example, because some aneurysms are round protrusions and others are balloon-like objects, which appear on intracranial vessels, many aneurysm shapes were hemispherical or spherical. Therefore, in order to enhance aneurysms and suppress other objects such as vessels, the isotropic 3 D MRA images are processed by use of the dot-enhancement filter, and the dot-enhanced images are employed for identification of initial aneurysm candidates and segmentation of candidate regions. Furthermore, the isotropic 3 D images are processed by use of line- and plane-enhancement filters for “vessels” (i.e., blood flow), and vessel walls (i.e., surface of blood flow) for determination of localized image features (average voxel value and standard deviation of voxel value) of aneurysm candidates, because these image features for aneurysms are different from those for non-aneurysms in the line- and plane-enhanced images.

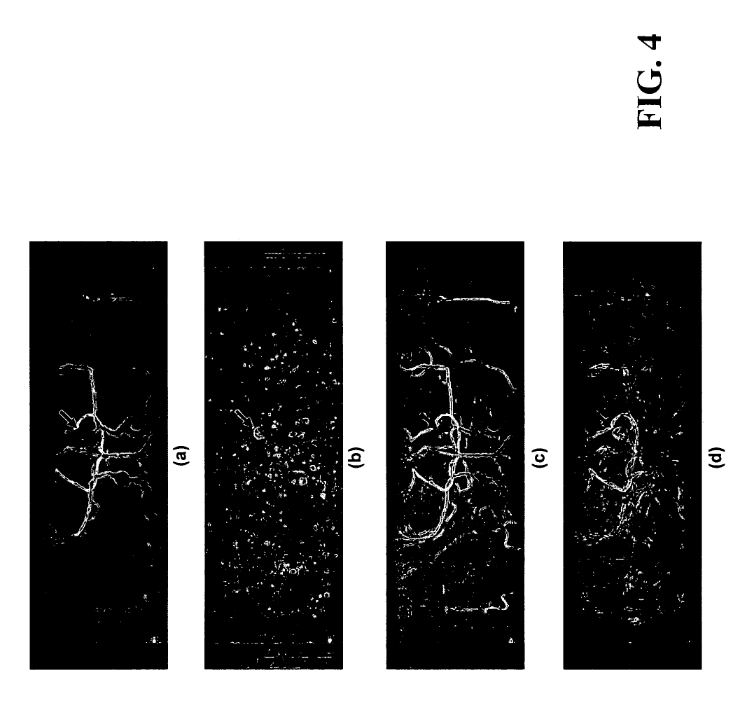

FIG. 4 shows (a) an original MRA image and three images selectively enhanced for (b) dot, (c) line, and (d) plane objects, all of which were produced by MIP image processing. In the dot-enhanced image (b), an aneurysm was enhanced well and “vessels” disappeared, although some “non-aneurysms” were also enhanced, which included bending regions and vessel bifurcations. On the other hand, the aneurysm disappeared in the line-enhanced image (c), but most of the vessels remained, and the walls of the aneurysm and vessels were enhanced in the plane-enhanced image (d).

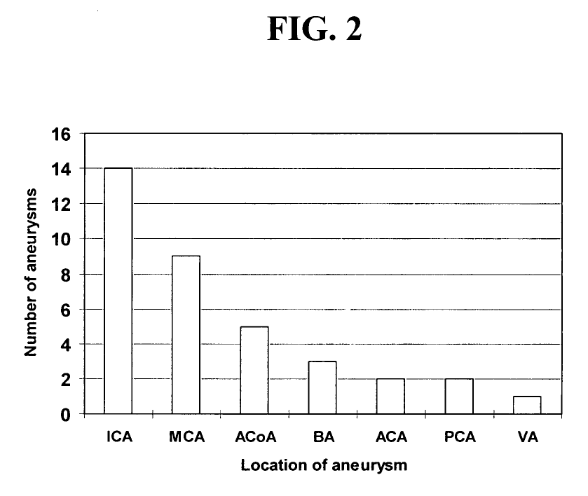

In steps 303-306, initial aneurysm candidates are obtained. As shown in FIG. 2, most aneurysms appear on specific vessels, i.e., the internal carotid artery (ICA) and middle cerebral artery (MCA), anterior cerebral artery (ACA), posterior cerebral artery (PCA), basilar artery (BA), anterior communicating artery (ACoA), posterior communicating artery (PCoA), vertebral artery (VA), etc., which are major vessels and small vessels bifurcated from major vessels. Therefore, it is reasonable to assume that the area for searching initial candidates would be related to major vessels and adjacent regions with small bifurcated vessels. By selecting a limited search area for initial candidates of aneurysms, the number of false positives, which would be located in irrelevant areas such as brain regions, can be reduced.

In step 303, objects such as major vessels are segmented on each isotropic image by use of linear discriminant analysis [24] on the histogram of voxel values in a cube (10 mm×10 mm×10 mm), which includes the voxel with the maximum value near the center of each image and its surrounding volume. The histogram usually contains two main peaks for major vessels and the background, and a threshold value is automatically determined for segmenting the region with major vessels. However, irrelevant objects other than major vessels are usually also segmented at this stage. To identify only major vessels from all segmented objects, the four largest objects are selected from the objects within a large cylinder with a length equal to the depth of the isotropic 3 D image and a diameter slightly larger than the Willis circle near the center of the image.

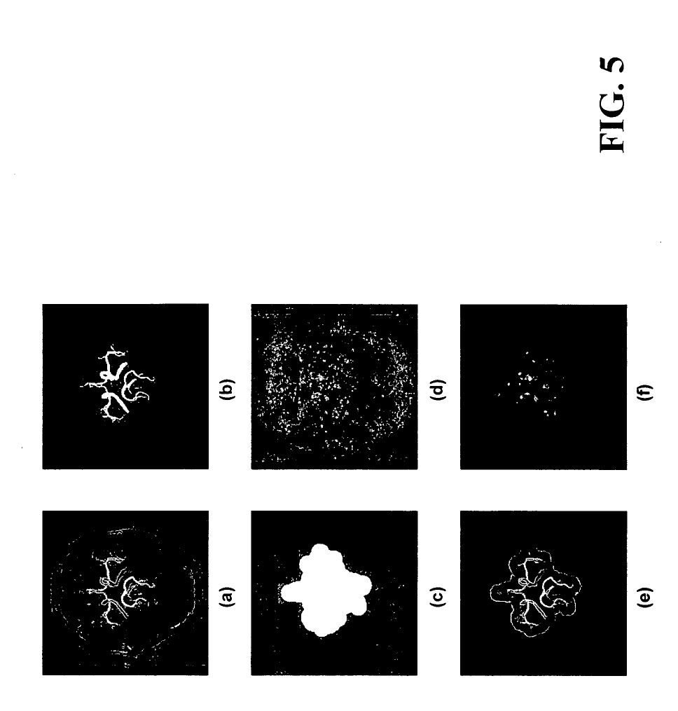

In step 304, for determining the search area, which is defined by a distance of 10 mm from the surface of the segmented major vessels, the segmented major vessels are dilated by use of a morphological filter with a circular kernel (20 mm diameter). FIG. 5 shows the original image (a) and the segmented major vessels (b), respectively. FIG. 5 also shows the search area (c), dot-enhanced image (d), and search areas in the original (e) and dot-enhanced (f) images, respectively. It is important to note that many of the enhanced background structures (d) shown in FIG. 5 could become false positives, but are excluded from the search area of the dot-enhanced image (f), whereas most of vessels and adjacent regions, where aneurysms are commonly located, are included in the search area of the original image (e) shown in FIG. 5.

In step 305, for identification of initial aneurysm candidates, a multiple-gray-level thresholding technique is applied to the dot-enhanced image which is smoothed by averaging with a square kernel (3×3×3) to reduce noise. Each threshold level is determined according to a certain specific upper percentage of the area under the pixel-value histogram in the dot-enhanced image within the search area. The pixel values of aneurysms in the dot-enhanced image are usually located at the high end of its histogram (the portion of the histogram closest to the highest pixel value), which ranged from approximately 0.008% to 0.8% for the cases used in a study based on the present invention. The regions in the dot-enhanced image above a certain threshold value are called “islands” (3 D objects in 3 D space), which are initial candidates. Note that the area under the histogram for each threshold level is equivalent to the total volume of all islands emerged. For picking up initially as many aneurysms as possible, the island volume and the corresponding threshold level should be increased by a small enough volume for detecting a small aneurysm. Therefore, the incremental percentage of the area under the histogram for each threshold level is determined empirically by a fraction of a small volume relative to the total volume of the search area, which is equivalent to the total area of the histogram; e.g., a small volume of approximately 20 mm³ and 85 mm³ (the corresponding cube size of approximately 2.7 mm and 4.4 mm) for higher and lower threshold levels, respectively. At the first % threshold level where each island emerged (referred to as “starting % threshold level”), the effective diameter is determined for selection of initial aneurysm candidates. The effective diameter of a candidate is defined by the diameter of a sphere with the same volume as that of the candidate. If the effective diameter of an island is greater than 2 mm at the starting % threshold level, the island is considered an initial aneurysm candidate. An initial candidate thus selected at a starting % threshold level is not examined again at the subsequent % threshold levels.

In step 306, for each of the initial candidates, the region of the initial candidate is determined by applying a region-growing technique to the dot-enhanced image in order to obtain the image features of the candidates for subsequent rule-based schemes. The candidate regions are determined within a volume of interest (VOI) (40 mm×40 mm×40 mm), where the center of the VOI is located at the voxel with a maximum value for each initial candidate in the dot-enhanced image. The segmentation of the candidate region is based on finding a large change in some image features, which implies that the candidate region merges with its adjacent background structures or other candidates, as the candidate region grows. The region growing begins at the location where the voxel value is the maximum in the initial candidate region, and is repeated at various gray levels, which are decreased from each previous gray level with a decrement of 5% of the maximum voxel value. The percentage of a gray-level decrease from the maximum value, which is referred to as “% gray level,” changes from 5% to 90%. At each % gray level, two image features for the candidate grown region, i.e., the effective diameter and average contrast, are determined for finding the large change in these features. The average contrast is defined by the difference in the average voxel values between the inside and outside regions in the original image divided by the average voxel value of the inside region. The inside and outside regions for each candidate is defined by the candidate region at a current % gray level and the increased region at the subsequent % gray level, respectively.

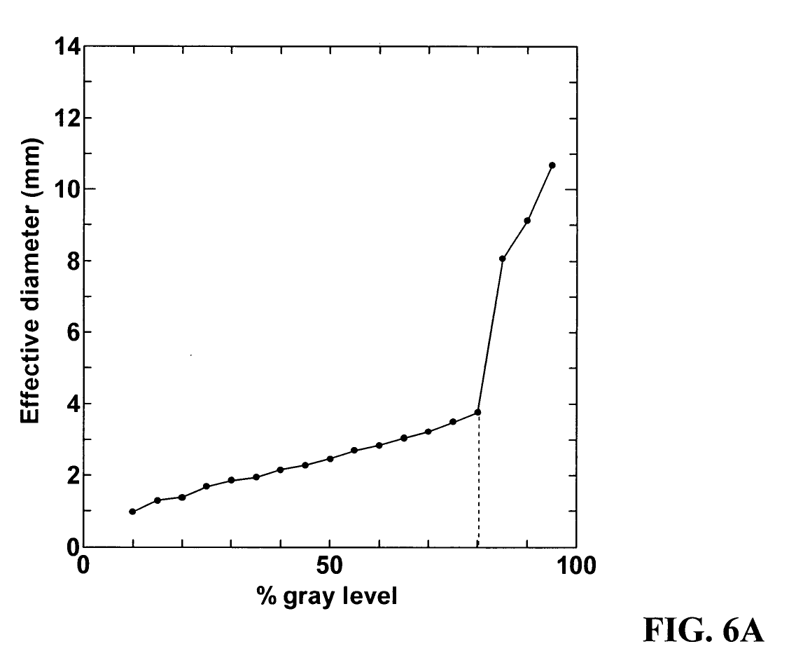

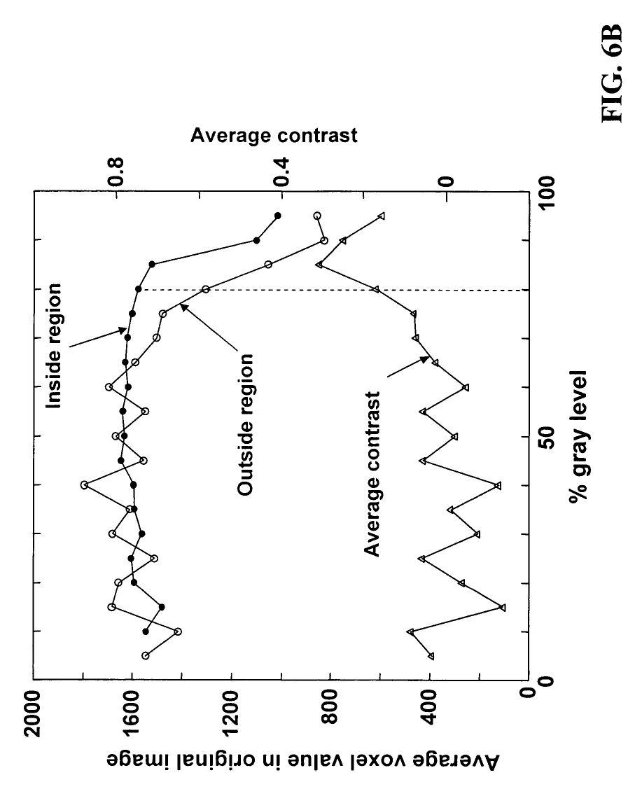

FIG. 6A shows the abrupt change in the effective diameter as the % gray level increased. At a certain % gray level, the effective diameters of many candidates tended to increase abruptly. This abrupt change in the size indicated that the candidate merged with its adjacent background structures or other candidates at that % gray level. The % gray level just before the abrupt change occurs was referred to as a ‘transition point,’ shown by a dotted line in FIG. 6A. FIG. 6B shows the changes in the average voxel values in the inside and outside regions, and the average contrast, as the % gray level increased. If the outside region at a certain % gray level included the adjacent background, the average voxel value in the outside region became much lower than that in the inside region, and the average contrast tended to become large. By finding this large change in the average contrast, the candidate region could be segmented properly so that the candidate region would not be extended beyond the surface of the aneurysm or vessel in the original image. Therefore, the candidate region was segmented by detection of these transition points on the effective diameter and the average contrast, as shown by the dotted lines in FIGS. 6A and 6B.

The transition point was thus found by either one of the two methods: (1) a large change in the size, i.e., when the subsequent effective diameter increased by more than 1.5 times the current effective diameter, and (2) a large change in the average contrast of the grown region, i.e., when the average contrast increased by more than 0.2. For candidates without the transition points, however, the candidate regions were determined at the 90% gray level.

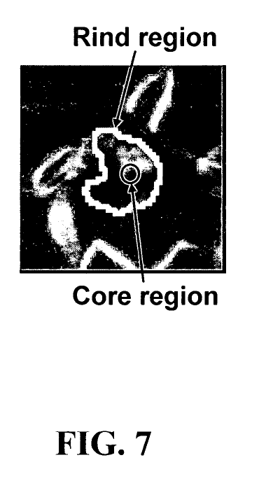

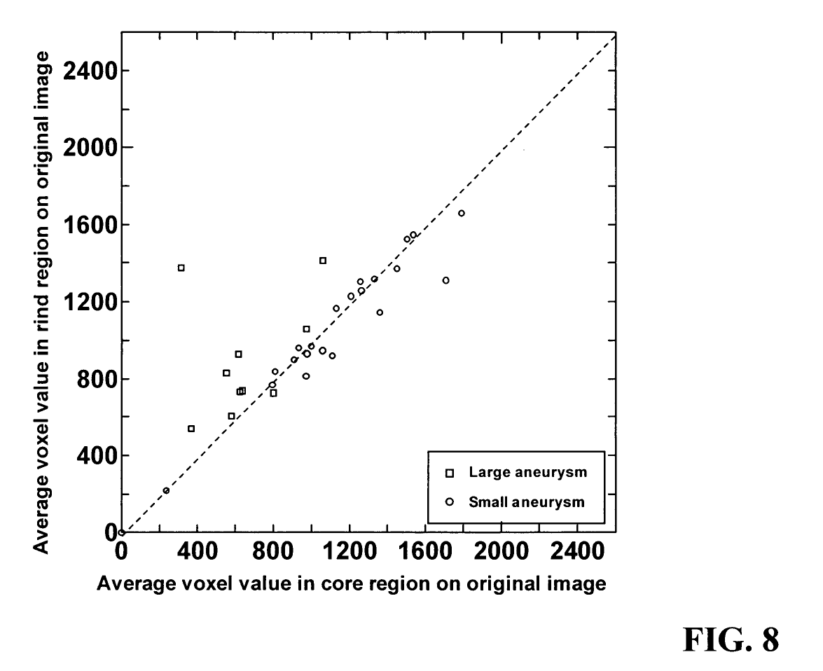

In step 307, all initial candidates are grouped into small and large candidates based on their effective diameters. It is important to note that the characteristics of large aneurysms in MRA images are quite different from those of small aneurysms. For example, the voxel values in the core region (near the center) for large aneurysms are commonly lower than those in the rind region adjacent to the aneurysm wall due to the slow speed or turbulence of blood flow inside the aneurysm. By observing the original axial images of many aneurysms, it was found that aneurysms with diameters larger than about 6.5 mm had this unique characteristic. To determine the average voxel values in the core and rind regions on the original image, the core and the rind regions are defined by a 2-mm sphere at the centroid, and a 1-mm thick region inside the surface of the candidate region, respectively, as shown in FIG. 7. FIG. 8 shows the relationship between the average voxel values in the core and rind regions for small and large aneurysms, where a threshold size of 6.5 mm was used for classification. In general, the average voxel values of large aneurysms in the rind region on the original image were greater than those in the core region, whereas the average voxel values of small aneurysms in the rind region were close to or smaller than those in the core region. Initial candidates were grouped into small and large candidates by use of an effective diameter of 6.5 mm.

In step 308, some of the small and large false positives are removed by use of different rules in each group (the first rule-based scheme). For the initial removal of small and large false positives, the image features on the gray level, size, and shape are employed. Generally, the sizes of some false positives are smaller or larger than those of aneurysms, and some are less circular or more irregular compared with aneurysms. The average voxel values, standard deviations (SDs), and contrasts of some false positives are smaller or larger than those of aneurysms, because of slow blood flow in some small vessels or fast speed in the bifurcation or bending regions on some vessels, respectively, and also for some other reasons due to the turbulence of the blood flow inside some aneurysms, and the nonuniform blood flow speed inside some vessels with nonuniform diameters.

Therefore, the gray level features are determined in the dot-enhanced and original images, i.e., the average voxel value, the relative SD of voxel value, the relative contrast, the average contrast (defined in subsection D.3), the relative difference in the SD of voxel values between the candidate and outside regions, and the morphological features, i.e., the effective diameter, the sphericity, the relative SD of the distance between the centroid and the surface, and the maximum and minimum distance between the centroid and the surface. The ‘relative’ value means the value relative to the average value. The degree of sphericity is defined by the fraction of the overlap volume between the candidate region and the sphere (with the same volume as the candidate volume). The relative SDs of voxel values are obtained in both the candidate and outside regions, because local structures inside and outside aneurysms could differ from those for false positives. The relative contrast used is defined by the difference between the maximum and minimum voxel values within the candidate region divided by the average voxel value. The average voxel values and the relative SD of the voxel values are determined in the line- and plane-enhanced images as well, because, as shown in FIG. 4, aneurysms almost disappeared, but vessels were enhanced well in the line-enhanced images, and the appearances inside the aneurysm surfaces were different from those of the “non-aneurysm” vessels in the plane-enhanced images. The relative SD of the distance between the centroid and the surface is related to the degree of irregularity for the surface of the candidate region. In addition, for removal of large false positives, specific features relevant to the characteristics of large aneurysms are determined, i.e., the average voxel values in the core and rind regions on the original image, the relative SDs of the voxel values in both regions, the relative differences in the average voxel values and the SDs between the core and rind regions.

All of the rules used in the two rule-based schemes are based on removal of false positives by use of simple thresholding for both the upper limits and the lower limits of the features determined from all aneurysms included in each group; upper and lower limits were obtained, respectively, by 5% higher and 5% lower than the maximum and minimum values of each feature. If one of the features for a candidate is larger than the upper limit or smaller than the lower limit, the candidate is removed as a false positive.

In step 309, the remaining small candidates are further classified into three groups according to the local structures based on the skeleton image, which include a short-branch type, a single-vessel type, and a bifurcation type (including trifurcation), and some of the three types of false positives are removed by use of another set of different rules in each group (the second rule-based scheme). It should be noted that the image features for small aneurysms and non-aneurysms are different in each group because of differences in the types of local structures. Therefore, small candidates are classified into three groups (short-branch type, single-vessel type, and bifurcation type), and a number of effective rules to remove many non-aneurysms in each group are established. Grouping is made according to the local structures based on the skeleton image, which is obtained from the distance-transformed image, because the topological properties (based on connectivity) are preserved in the skeleton image [25,26]. For example, the structure of a vessel is simplified by maintaining voxels with only one voxel width. The local structure of the candidate is determined by counting the number of the skeleton objects in a rind region (a rind thickness of 1.0 mm) of a sphere of diameter 1.4 times larger than the candidate region. For example, if the number of the skeleton objects is one or two, the local structure is a vessel end or a single vessel, respectively.

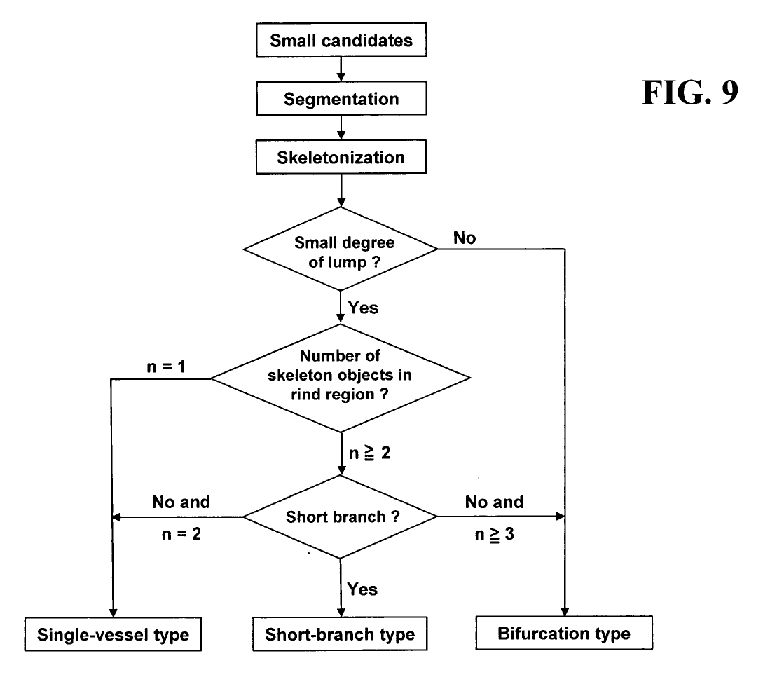

FIG. 9 shows the schematic diagram for classification of small candidates into three groups based on the skeleton image. First, the candidate region was segmented within the VOI (30 mm×30 mm×30 mm) in the original image, where the centroid of the candidate region is located at the center of the VOI by use of the region growing technique, which is similar to that used for the dot-enhanced image. The distance-transformed image is derived by calculation of a Euclidean minimum distance from each voxel in the segmented region to the nearest background in the binary image [25]. Next, the skeleton image is obtained by use of a thinning algorithm [26] based on the distance-transformed image, where deletable voxels with smaller distance values are removed first so that the topological properties of the segmented vessels are preserved.

For classification of the local structures, the skeleton images of candidates are analyzed as shown in FIG. 9. Note that “lump” candidates and short-branch-type candidates are identified in this classification scheme, as described in detail in the next two paragraphs. If the degree of lump for the candidate (defined in the next paragraph) is smaller than 0.1, the number of skeleton objects is counted in the rind region. If not, the candidates are classified as the bifurcation type, because most aneurysms with a degree of lump greater than 0.1 are located at the bifurcation. If the number of skeleton objects in the rind region is one, the local structure is considered as a single vessel. If the number of the skeleton objects is equal to or greater than two, the nearest short branch is searched in the large sphere including the original candidate. If a short branch is found, then the candidate is determined as the short-branch type. If the short branch is not found, and if the number of the skeleton objects is equal to two, the candidate is a single-vessel type; if the number of skeleton objects is equal to or greater than three, the candidate is a bifurcation type.

The skeleton objects for some candidates have a “lump” composed of many short “skeletons,” which look like short hairs and are not “true” skeletons; therefore, the number of the skeleton objects in the rind region is incorrect. Thus, before counting the skeleton objects in the rind region, the degree of lump for each candidate is determined for identifying the “lump” candidates, where the degree of lump is defined by a fraction of the total volume of skeleton objects in a 2.0-mm sphere which is placed at the centroid of the candidate region.

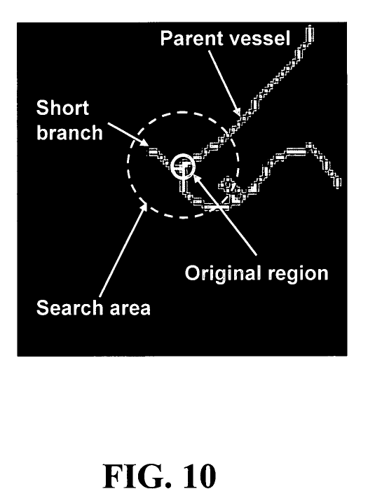

A small protrusion, a small branching vessel (non-aneurysm), and a small aneurysm on a single vessel or bifurcation (parent vessel) in the original image is considered as a short branch attached to a parent skeleton in the skeleton image, as shown in FIG. 10. Such candidates with a short branch are referred to as short-branch type and should be examined carefully, because this short branch could be an aneurysm. Note that some small aneurysms adjacent to large regions, such as the bending region of a large parent vessel, are hardly enhanced in the dot-enhanced image, because such large regions tend to be strongly enhanced by the dot-enhancement filter. Such small aneurysms are detected by finding the short branch adjacent to the original candidate region in the skeleton image. Thus, the short branch is searched as illustrated in FIG. 10: (1) the nearest short branch with an end point is searched within a sphere of diameter four times larger than the original candidate region, and the large sphere is placed at the centroid of the original candidate region; (2) if the short-branch length is larger than the radius of a parent vessel, and if the difference between the length and the radius is in the range from 1.5 mm to 6.5 mm, then the short branch could be a small protrusion on the parent vessel or a small aneurysm; and thus, (3) the short branch is considered as a new candidate of a short-branch type at this stage. Otherwise, the candidate is classified into either the bifurcation type or single vessel type. The difference between the short-branch length and the radius of a parent vessel is defined as the protrusion length, which was obtained as an image feature for the short-branch-type candidates used in the second rule-based scheme. Because both the short branch and the vessel end have an end point, it is difficult to distinguish between them. Therefore, it is not examined whether the vessel-end candidates are the short-branch type, and the vessel-end candidates are classified as the single-vessel type, because a vessel end consists of a single vessel.

In step 310, in the second rule-based scheme for further removal of many small false positives (more than 80% false positives) for each group of the candidates, respective rules based on the localized image features are used. In this rule-based scheme, additional localized features are determined in both the distance-transformed image and the candidate region segmented in the original image. Note that the distance value in the distance-transformed image is related to the thickness of the vessel or the diameter of the vessel cross-section. In general, because small aneurysms may be considered as protrusions on the vessels, the diameter of the vessel cross-section with the aneurysm would be larger than the vessel without the aneurysm. Therefore, the maximum distance values in the candidate and the outside regions, and the average distance values in the outside regions are obtained from the distance-transformed image, and also the relative difference in the maximum distance values (and the average distance values) between the candidate and the outside regions are determined.

For the segmentation of the candidate region in the original image, a region growing technique is applied as described above. It was found, however, that not only the regions of the aneurysms (and false positives), but also connected vessels were segmented at this stage. Therefore, the candidate region in the original image is segmented by region growing only within the dilated volume of the candidate region obtained in the dot-enhanced image. However, for candidates of the short-branch type, the dilated volume is derived by dilation of the skeleton image of the short branch, because the candidates of the short-branch type are found based on the skeleton image, not the dot-enhanced image. The morphological features for the candidate region in the original image include the effective diameter, the sphericity, the relative SD of the distance between the centroid and the surface, and the maximum and minimum distances between the centroid and the surface, which are the same as those used for the candidate region obtained in the dot-enhanced image. Additional features are determined for the short-branch-type candidates, i.e., the protrusion length and the average distance value in the candidate region obtained from the distance-transformed image.

All of the rules used in the second rule-based scheme are based on removal of false positives by use of the same simple thresholding (upper and lower limits) as those used in the first rule-based scheme described above.

In step 311, a classifier is used to classify all remaining candidates as false positives or abnormalities, such as aneurysms. In an embodiment of the present invention, forty-three image features are used for the LDA for further removal of false positives. However, because the short-branch-type candidates are detected only in the second step for the removal of small false positives, the number of features for the short-branch-type candidates is limited, i.e., the average voxel value, the relative SD of the voxel value, the relative contrast in the original image, and the effective diameter, the sphericity, the relative SD of the distance between the centroid and the surface, and the maximum and minimum distances between the centroid and the surface. Because some of the features are insignificant, the most effective combination of image features are selected by use of a linear discriminant function for classification of the remaining candidates as aneurysms or false positives. The receiver operating characteristic (ROC) curves are determined for distinction between aneurysms and false positives by use of the stepwise feature selection method based on Wilks' lambda, which is defined by the ratio of within-group variance to the total variance, and the F value, which is a cost function based on Wilks' lambda [27,28]. Consequently, the final combination includes four features, i.e., the average voxel value, the relative SD of the voxel value, the relative SD of the distance between the centroid and the surface, and the difference between the maximum and minimum distance (between the centroid and the surface). For determining the free response receiver operating characteristic (FROC) curve of the CAD scheme by use of the LDA, a round-robin test method is performed per candidate-basis (or leave-one-out test). With this method, all candidates except one are used for training, and the one candidate left out is used for testing with the linear discriminant function. This procedure is repeated for all candidates, so that each candidate is used once as a test candidate.

Study

For evaluation of possible intracranial vascular disease, MRA studies of 60 patients were acquired on a 1.5 T MRI scanner (Magneto Vision, Siemens Medical Systems, Erlanger, Germany) by use of a 3 D time-of-flight technique in the Department of Radiology, Kumamoto University. Each axial image was 512×512 pixels with a pixel size of 0.391 mm for 56 cases, and a pixel size of 0.410 mm for 4 cases. The 3 D MRA images included 128 slices for 55 cases with a slice thickness of 0.5 mm, 96 slices for 2 cases with a slice thickness of 0.67 mm, and 64 slices for 3 cases with a slice thickness of 1.0 mm. All original 3 D MRA images were converted to isotropic volume data, which were used for training and testing in this study, by use of linear interpolation and/or cropping, where each of the volume data was 400×400×128 voxels with a voxel size of 0.5 mm.

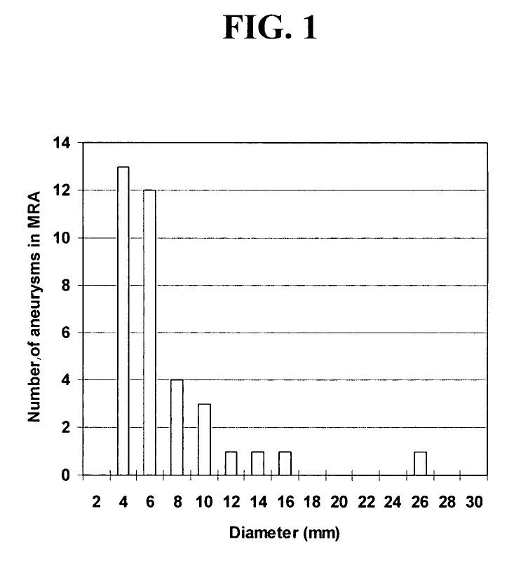

The clinical cases used in this study consisted of 29 cases with 36 aneurysms (diameter measured by radiologists: 3-26 mm, mean of 6.6 mm) and 31 non-aneurysm cases. Thirty-one non-aneurysm cases included 26 normal and 5 abnormal cases with other vascular diseases, i.e., old brain infarction, old brain hemorrhage, intracranial steno-occlusive disease, meningioma, pituitary microadenoma, and azygous anterior cerebral artery, whereas 12 of 29 aneurysm cases also included other vascular diseases. FIG. 1 shows the distributions of measured diameters for the 36 unruptured aneurysms. About two thirds of all aneurysms were smaller than 6.0 mm, and one aneurysm was very large. Thirty-four aneurysms were saccular in shape, and two were fusiform. FIG. 2 shows the distribution of aneurysms at various locations, which was considered similar to the distribution in a clinical environment. About two thirds of all aneurysms were found on the internal carotid artery (ICA) and middle cerebral artery (MCA).

An embodiment of the present invention for the detection of the intracranial aneurysms in MRA was applied to the 31 non-aneurysm cases and 29 abnormal cases with 36 aneurysms, for which image data was obtained as discussed above. MRA images of all cases were processed by use of the selective enhancement filter for dots. Most of the aneurysms were enhanced well in the dot-enhanced image, as shown in FIG. 4B. Initial aneurysm candidates with an effective diameter greater than 2 mm were identified based on the multiple gray-level thresholding technique and the region growing technique in the dot-enhanced image. All of the 36 aneurysms with 22.3 false positives per patient were detected at the initial identification step. For evaluation of an embodiment of the present invention, a criterion was employed such that an aneurysm was considered correctly detected, if the location of the maximum voxel value in the candidate region was within the diameter of the aneurysm measured by radiologists for aneurysms smaller than 7.0 mm, and within the diameter of 7.0 mm for aneurysms larger than 7.0 mm.

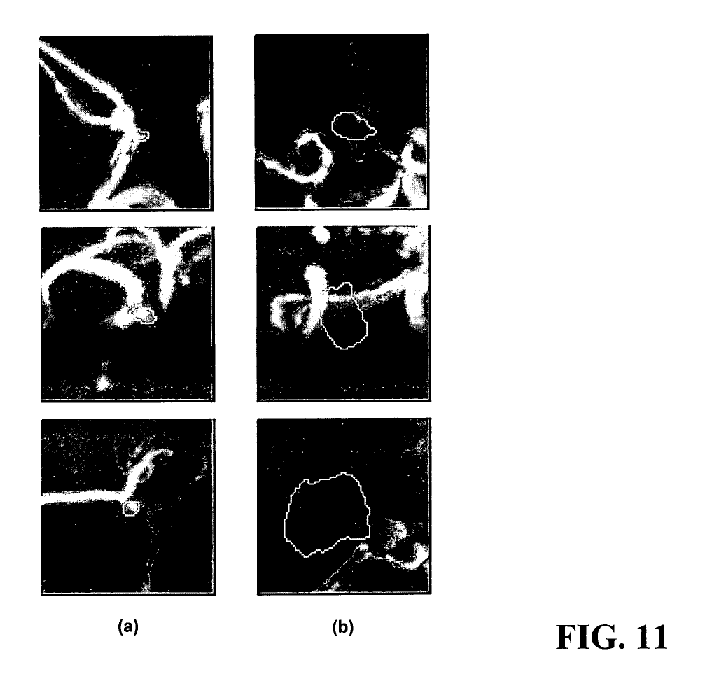

FIG. 1 shows the results obtained with the segmentation of (a) small and (b) large aneurysms by use of the region growing technique on the dot-enhanced or original images, where most of small and large aneurysms were segmented well. However, segmentation of large aneurysms tended to be less accurate, where not only the aneurysm but also adjacent vessel regions (or background) were included in the segmented candidate region, e.g., large aneurysms in the middle and bottom of FIG. 11B. These inaccuracies of segmentation occurred, because the contrasts of the surface area of such large aneurysms were very low, and the average voxel values in the core region for the aneurysms were lower than those in the rind region, as shown in FIG. 8. Nevertheless, it was not difficult to distinguish between large aneurysms and large false positives, because of the unique image features of large aneurysms, as illustrated in FIG. 8.

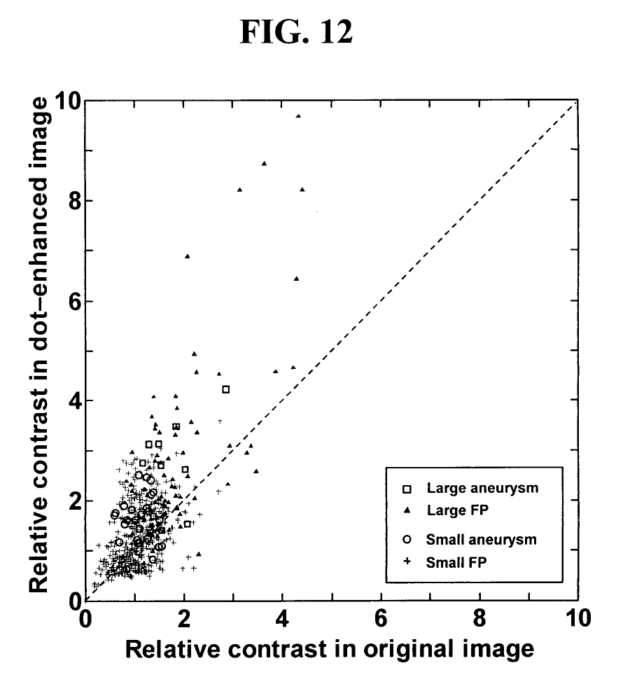

In the first rule-based scheme, all initial candidates were grouped into small and large candidates, and many false positives were removed by use of rules based on the localized image features. FIG. 12 shows the relationship between the relative contrast in the original image and the relative contrast in the dot-enhanced images for small and large aneurysms as well as small and large false positives. The relative contrasts of most candidates in the dot-enhanced image were greater than those in the original image. This result shows the usefulness of the dot-enhancement filter on the increased contrast of the initial candidates. However, the contrasts of some false positives such as very small vessels and bending regions of the vessels were lower and higher, respectively, than those of the aneurysms. Thus, such false positives, which were different from the aneurysms in terms of image features, were removed by use of simple rules in each group.

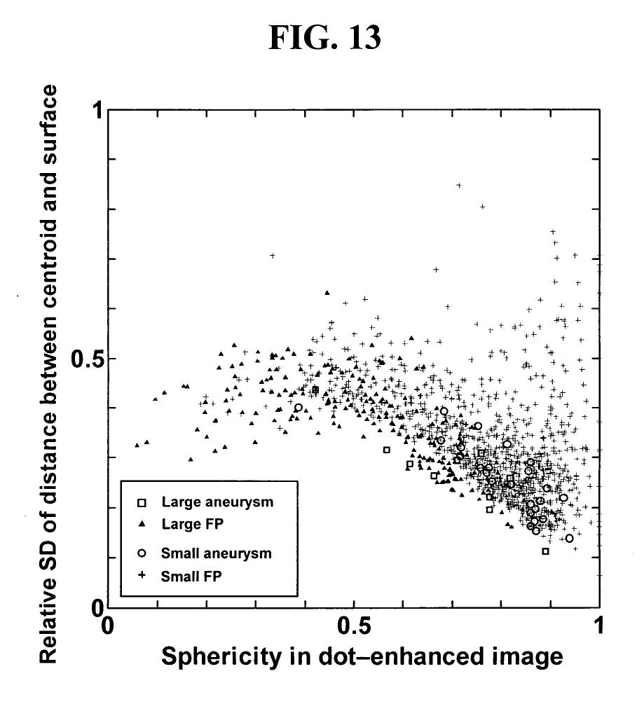

FIG. 13 shows the relationship between the sphericity and the relative SD of the distance between the centroid and the surface for small and large aneurysms as well as small and large false positives in the dot-enhanced image. In general, the relative SD of the distance between the centroid and the surface decreased as the sphericity increased, because the relative SD of the distance would be related to the degree of irregularity, which generally decreases as the sphericity increases. Note, however, that some false positives with very small sphericities such as large vessels can be removed, because the shape of aneurysms tended to be round, thus yielding relatively large sphericities. In addition, some small false positives with very large sphericities could be removed because such false positives contained a large relative SD of distance between the centroid and the surface, probably due to irregular surfaces.

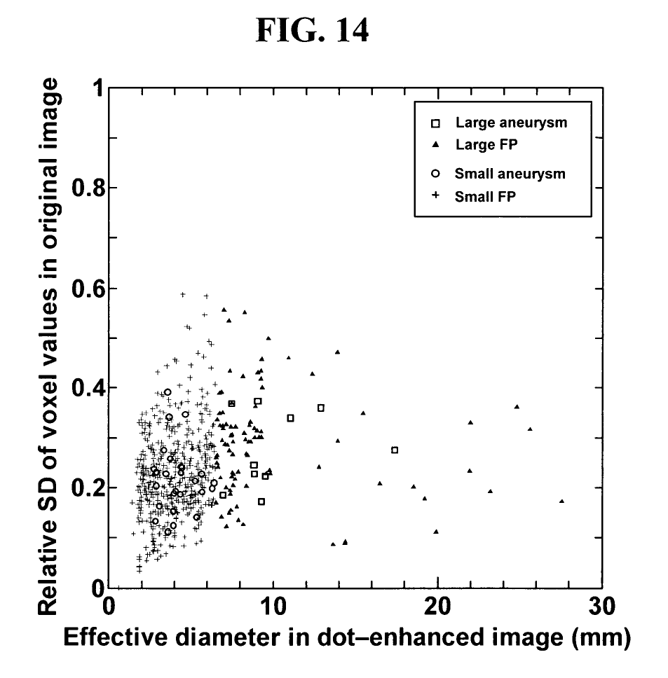

FIG. 14 shows the relationship between the effective diameter in the dot-enhanced image and the relative SD of the voxel value in the original image. The effective diameters of some false positives such as small short vessels and large long vessels were smaller and larger, respectively, than those of aneurysms. In addition, because the distribution of voxel values inside some vessels (e.g., vessels of elderly patients with stenosis and occlusion) were more nonuniform than those of aneurysms, the relative SDs of the voxel values for these false positives were greater than those of aneurysms. By use of the first rule-based scheme for the initial removal of small and large false positives, all aneurysms were retained, and the average number of false positives per patient was reduced from 22.3 to 5.8. At this stage, the majority of remaining false positives were due to bending single vessels and bifurcation vessels, most of which were further removed by use of the second rule-based scheme, as described below.

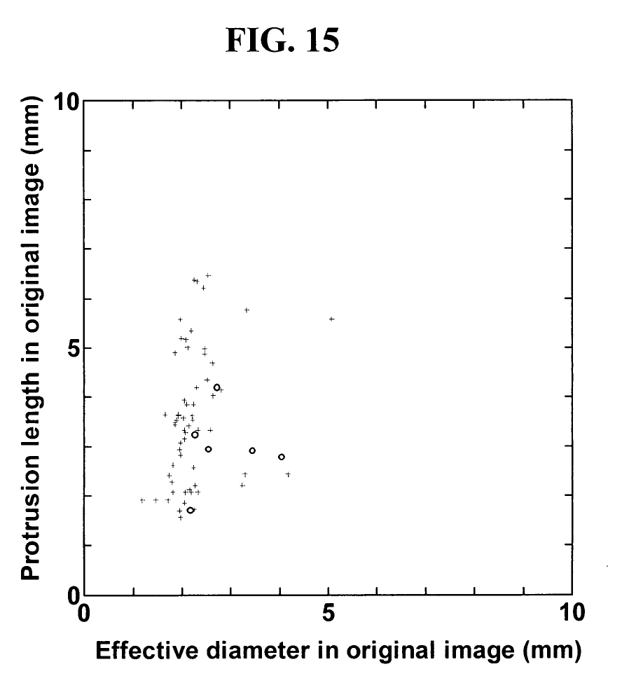

For short-branch-type candidates, FIG. 15 shows the relationship between the effective diameter in the original image and the protrusion length. The effective diameter and the protrusion length of some false positives such as very small vessels bifurcated from parent vessels were smaller and larger, respectively, than those of aneurysms.

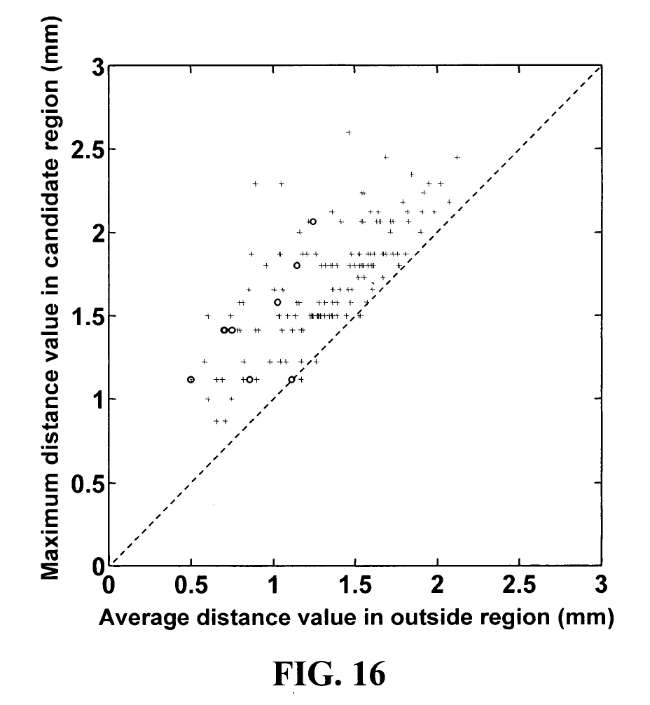

For single-vessel-type candidates, FIG. 16 shows the relationship between the average distance values in the outside region and the maximum distance values in the candidate region, where the distance values were obtained from the distance-transformed images. Note that many bending regions of large vessels were included as false positives in single-vessel-type candidates, and the average distance values in the outside region for such false positives were larger than those of aneurysms as shown by many false positives on the right side in FIG. 16. In addition, the difference in the distance values between the candidate region and outside region tended to be larger for aneurysms than those for most of the false positives.

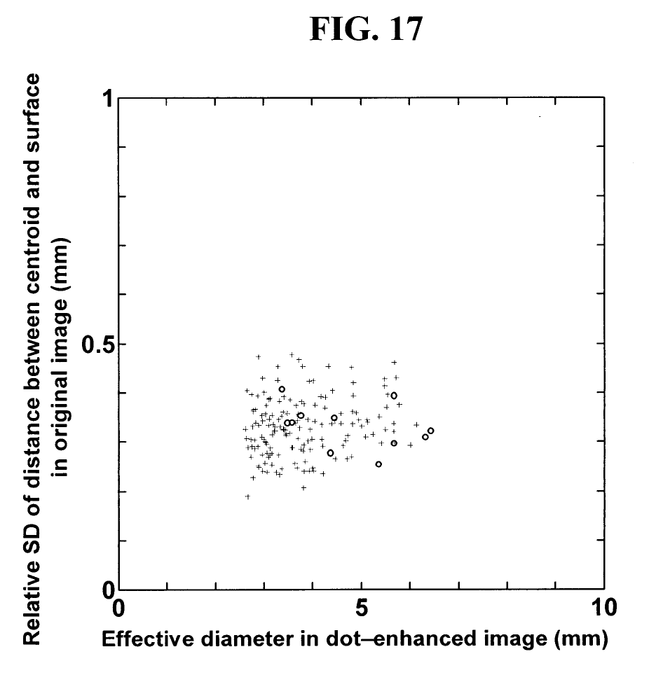

For bifurcation-type candidates, FIG. 17 shows the relationships between the effective diameter in the dot-enhanced image and the relative SD of the distance between the centroid and the surface. The effective diameters of some false positives located on the bifurcations were smaller than those of aneurysms located on the bifurcations. Moreover, some false positives in bifurcation-type candidates were more irregular than aneurysms.

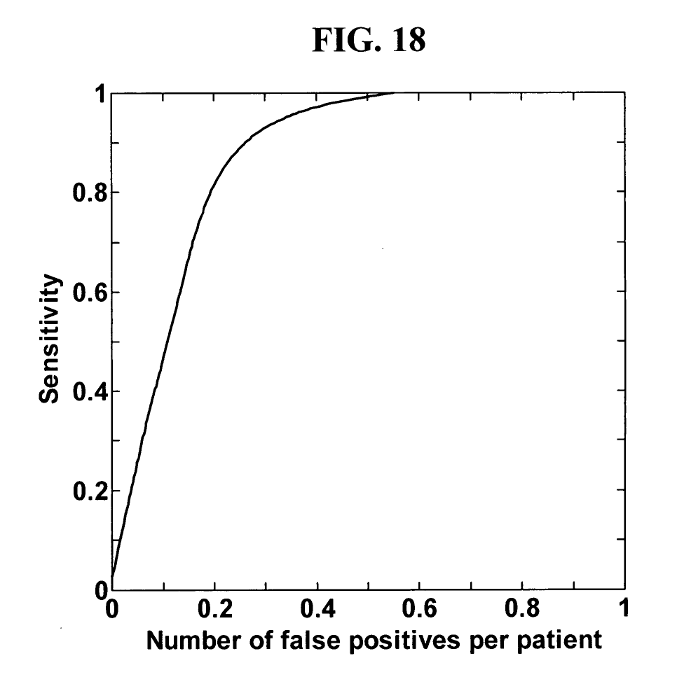

Finally, many false positives in each group were removed based on the differences in the image features between aneurysms and false positives as shown in FIGS. 15, 16, and 17. As a result, all 36 aneurysms were detected correctly with 0.55 false positives per patient. FIG. 18 shows the FROC curve for the overall performance of our scheme by use of LDA. According to this result, our CAD scheme achieved a sensitivity of 90% with 0.26 false positives per patient.

In conclusion, all of the 36 aneurysms in 60 cases were detected correctly with 0.55 false positives per patient. Thus, embodiments of the present invention would be useful in assisting radiologists in the detection of unruptured intracranial aneurysms in MRA.

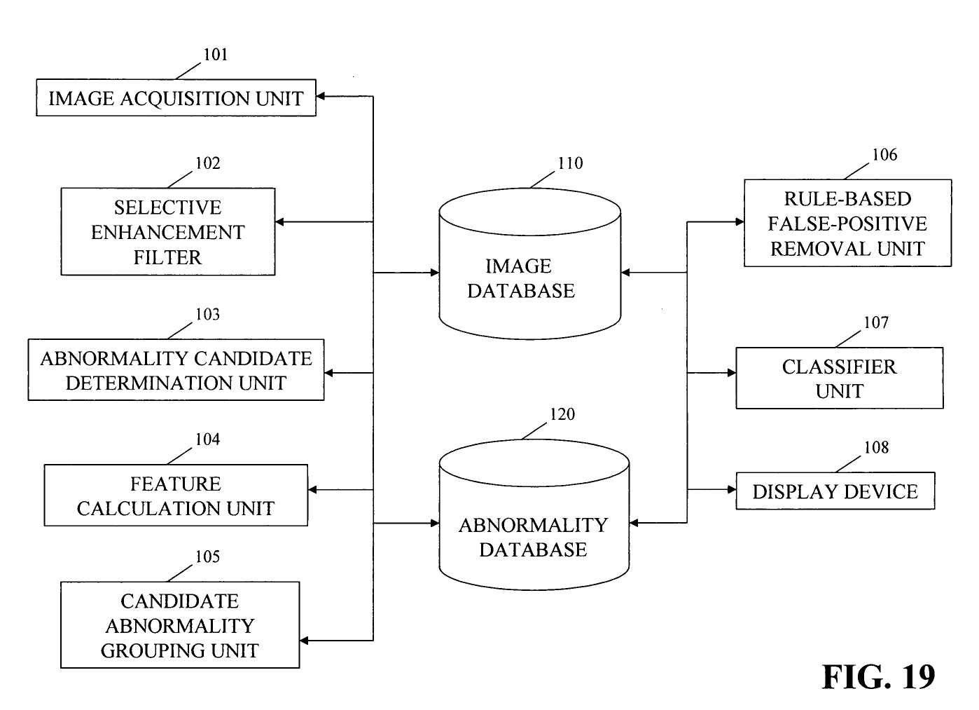

FIG. 19 illustrates a system configured to implement the detection of abnormalities such as aneurysms in medical images.

The image acquisition unit 101 is configured to produce three-dimensional isotropic volume data from a plurality of axial images, e.g., MRA axial images. For example, each axial image could be 512×512 pixels with a pixel size of 0.391 mm and 128 slices having a slice thickness of 0.5 mm. Then, all original 3 D MRA images would be converted to isotropic volume data by use of linear interpolation and/or cropping such that the volume data was 400×400×128 voxels with a voxel size of 0.5 mm. Axial and volume image data is stored in image database 110 and may be retrieved as necessary by the other system components.

The selective enhancement filter 102 is configured to enhance objects in the volume data having specific shapes. For example, in order to enhance aneurysms and suppress other objects such as vessels, the isotropic 3 D MRA images are processed by use of the dot-enhancement filter. Furthermore, the isotropic 3 D images are processed by use of line- and plane-enhancement filters for “vessels” (i.e., blood flow), and vessel walls (i.e., surface of blood flow) for determination of localized image features (average voxel value and standard deviation of voxel value) of aneurysm candidates, because these image features for aneurysms are different from those for non-aneurysms in the line- and plane-enhanced images. The selectively enhanced volume image data are stored in the image database 110.

The abnormality candidate determination unit 103 is configured to determine initial abnormality candidates using multiple-gray-level thresholding on the selectively enhanced image data. In determining initial abnormality candidates, the abnormality candidate determination unit 103 unit is also configured to segment major vessels on each isotropic image by use of linear discriminant analysis on the histogram of voxel values in a cube (10 mm×10 mm×10 mm), which includes the voxel with the maximum value near the center of each image and its surrounding volume. Further, for determining a search area, segmented major vessels are dilated by use of a morphological filter with a circular kernel. As described above, the region of an abnormality candidate region is determined by applying a region-growing technique to the selectively-enhanced image based on image features of the candidates determined by the feature calculation unit 104. The abnormality candidates determined by the abnormality candidate determination unit 103 are stored in the abnormality database 120 for use by other system units.

In addition to calculating feature values of the abnormality candidates in the region-growing process, the feature calculation unit 104 calculates feature values used by the candidate abnormality grouping unit 105, the rule-base false-positive removal unit 106, and the classifier unit 107.

The candidate abnormality grouping unit 105 is configured to group the candidate abnormalities into groups, e.g., large and small abnormalities. Further, the candidate abnormality grouping unit 105 is configured to group the small candidates into subgroups based on various features. For example, in the context of detecting aneurysms, small candidates are further classified into the three groups according to the local structures based on the skeleton image, which included a short-branch type, a single-vessel type, and a bifurcation type (including trifurcation). As described above, grouping is made according to the local structures based on the skeleton image, which is obtained from the distance-transformed image, because the topological properties (based on connectivity) are preserved in the skeleton image.

The rule-based false positive removal unit 106 is configured to remove false positive abnormalities from the various candidate groups determined by the candidate abnormality grouping unit. As described above, some of the small and large false positives are removed by use of different rules in each group under a first rule-based scheme. For example, for the initial removal of small and large false positives, the image features based on the gray level, size, and shape are used. Further, a second rule-based scheme is used for the further removal of many small false positives (more than 80% false positives) for each group of candidates. In this rule-based scheme, additional localized features are determined in both the distance-transformed image and the candidate region segmented in the original image. As described above, the rules used in the second rule-based scheme are based on removal of false positives by use of simple thresholding (upper and lower limits).

The classifier unit 107 is configured to classify the remaining abnormality candidates (those not removed by the rule-based false-positive removal unit 106) as either abnormalities or false positives. As discussed above, a linear discriminant may be used to classify the remaining abnormalities. Alternatively, another type of classifier, e.g., an artificial neural network, can be used to classify the remaining abnormalities. The output of the classifier unit 107 is displayed on the display device 108. Further, the outputs of the other system components may also be output on the display device 108.

For the purposes of this description we shall define an image to be a representation of a physical scene, in which the image has been generated by some imaging technology: examples of imaging technology could include television or CCD cameras or X-ray, sonar or ultrasound imaging devices. The initial medium on which an image is recorded could be an electronic solid-state device, a photographic film, or some other device such as a photostimulable phosphor. That recorded image could then be converted into digital form by a combination of electronic (as in the case of a CCD signal) or mechanical/optical means (as in the case of digitizing a photographic film or digitizing the data from a photostimulable phosphor). The number of dimensions which an image could have could be one (e.g. acoustic signals), two (e.g. X-ray radiological images) or more (e.g. nuclear magnetic resonance images).

All embodiments of the present invention conveniently may be implemented using a conventional general purpose computer or micro-processor programmed according to the teachings of the present invention, as will be apparent to those skilled in the computer art. Appropriate software may readily be prepared by programmers of ordinary skill based on the teachings of the present disclosure, as will be apparent to those skilled in the software art.

As disclosed in cross-referenced U.S. patent application Ser. No. 09/773,636, a computer 900 may implement the methods of the present invention, wherein the computer housing houses a motherboard which contains a CPU, memory (e.g., DRAM, ROM, EPROM, EEPROM, SRAM, SDRAM, and Flash RAM), and other optional special purpose logic devices (e.g., ASICS) or configurable logic devices (e.g., GAL and reprogrammable FPGA). The computer also includes plural input devices, (e.g., keyboard and mouse), and a display card for controlling a monitor. Additionally, the computer may include a floppy disk drive; other removable media devices (e.g. compact disc, tape, and removable magneto-optical media); and a hard disk or other fixed high density media drives, connected using an appropriate device bus (e.g., a SCSI bus, an Enhanced IDE bus, or an Ultra DMA bus). The computer may also include a compact disc reader, a compact disc reader/writer unit, or a compact disc jukebox, which may be connected to the same device bus or to another device bus.

Examples of computer readable media associated with the present invention include compact discs, hard disks, floppy disks, tape, magneto-optical disks, PROMs (e.g., EPROM, EEPROM, Flash EPROM), DRAM, SRAM, SDRAM, etc. Stored on any one or on a combination of these computer readable media, the present invention includes software for controlling both the hardware of the computer and for enabling the computer to interact with a human user. Such software may include, but is not limited to, device drivers, operating systems and user applications, such as development tools. Computer program products of the present invention include any computer readable medium which stores computer program instructions (e.g., computer code devices) which when executed by a computer causes the computer to perform the method of the present invention. The computer code devices of the present invention may be any interpretable or executable code mechanism, including but not limited to, scripts, interpreters, dynamic link libraries, Java classes, and complete executable programs. Moreover, parts of the processing of the present invention may be distributed (e.g., between (1) multiple CPUs or (2) at least one CPU and at least one configurable logic device) for better performance, reliability, and/or cost. For example, an outline or image may be selected on a first computer and sent to a second computer for remote diagnosis.

The present invention may also be complemented with additional filtering techniques and tools to account for image contrast, degree of irregularity, texture features, etc.

The invention may also be implemented by the preparation of application specific integrated circuits or by interconnecting an appropriate network of conventional component circuits, as will be readily apparent to those skilled in the art.

The source of image data to the present invention may be any appropriate image acquisition device such as an X-ray machine, CT apparatus, and MRI apparatus. Further, the acquired data may be digitized if not already in digital form. Alternatively, the source of image data being obtained and processed may be a memory storing data produced by an image acquisition device, and the memory may be local or remote, in which case a data communication network, such as PACS (Picture Archiving Computer System), may be used to access the image data for processing according to the present invention.

Numerous modifications and variations of the present invention are possible in light of the above teachings. For example, the invention may be applied to images other than MRA images.

Of course, the particular hardware or software implementation of the present invention may be varied while still remaining within the scope of the present invention. It is therefore to be understood that within the scope of the appended claims and their equivalents, the invention may be practiced otherwise than as specifically described herein.

1. A method for determining existence of an abnormality in at least one medical image, comprising:
obtaining volume image data corresponding to the at least one medical image;
filtering said volume image data using an enhancement filter to produce a filtered image in which a predetermined pattern is enhanced;
detecting, in said filtered image, a first plurality of abnormality candidates using multiple gray-level thresholding;
grouping, based on size and local structures, the first plurality of abnormality candidates into a plurality of abnormality classes;
removing false positive candidates from each abnormality class based on class-specific image features to produce a second plurality of abnormality candidates; and
applying the second plurality of abnormality candidates to a classifier and classifying each candidate in the second plurality of abnormality candidates as a false positive candidate or an abnormality.

2. The method of claim 1, wherein the obtaining step comprises:
obtaining three-dimensional magnetic resonance angiography (MRA) volume image data.

3. The method of claim 2, wherein the obtaining step comprises:
obtaining a plurality of axial MRA images; and
processing said plurality of axial MRA images to obtain isotropic volume image data, including at least one of interpolating and cropping of said plurality of axial MRA images.

4. The method of claim 1, wherein said filtering step comprises:
using a geometric enhancement filter to produce a filtered image in which a geometric pattern is enhanced.

5. The method of claim 1, wherein said filtering step comprises:
using a dot enhancement filter to produce a filtered image in which dot-like objects are enhanced.

6. The method of claim 1, further comprising:
identifying, in said filtered image, a search region corresponding to anatomy associated with the at least one abnormality,
wherein said detecting step comprises detecting said first plurality of abnormality candidates in said search region.

7. The method of claim 6, wherein the identifying step comprises:
segmenting major vessels in said filtered image; and
dilating the segmented major vessels in said filtered image using a morphological filter having a circular kernel.

8. The method of claim 6, wherein the identifying step comprises:
identifying a search region including a blood vessel associated with aneurysms.

9. The method of claim 1, wherein the detecting step comprises:
forming a pixel-value histogram in a search area of said filtered image;
selecting a threshold value based on said pixel-value histogram;
identifying islands in said filtered image having pixel values greater than the selected threshold;
determining an effective diameter of each island;
selecting islands having an effective diameter greater than a predetermined diameter to be in the first plurality of abnormality candidates; and
segmenting each of the first plurality of abnormality candidates by performing region-growing based on at least one image feature.

10. The method of claim 1, wherein the grouping step comprises:
calculating an effective diameter of each of the first plurality of abnormality candidates; and
grouping the first plurality of abnormality candidates into a large abnormality class and a small abnormality class based on the calculated effective diameter of each of the first plurality of abnormality candidates.

11. The method of claim 10, further comprising:
determining a skeleton image of each abnormality in the small abnormality class; and
partitioning the candidate abnormalities in the small abnormality class into at least two abnormality classes based on the determined skeleton images.

12. The method of claim 11, wherein the partitioning step comprises:
grouping the candidate abnormalities in the small abnormality class into a short-branch type abnormality class, a single-vessel type abnormality class, and a bifurcation type abnormality class based on the determined skeleton images.

13. The method of claim 12, wherein the removing step comprises:
calculating, based on the volume image data for each candidate abnormality in the short-branch type abnormality class, the single-vessel type abnormality class, and the bifurcation type abnormality class, at least one morphological feature including sphericity, a relative standard deviation of a distance between a centroid and a surface, and a maximum and a minimum distance between the centroid and the surface; and
removing the false positive candidates from the short-branch type abnormality class, the single-vessel type abnormality class, and the bifurcation type abnormality class based on the calculated morphological image features.

14. The method of claim 1, wherein the removing step comprises:
calculating the class-specific image features for each abnormality in each of the plurality of abnormality classes; and
removing the false positive candidates from each abnormality class based on the calculated class-specific image features.

15. The method of claim 14, wherein the class-specific image features include at least one of average voxel value, a relative standard deviation in voxel value, a relative contrast, an average contrast, effective diameter, sphericity, a relative standard deviation of a distance between a centroid and a surface, and a maximum and a minimum distance between the centroid and the surface.

16. The method of claim 1, wherein the applying and classifying step comprises:
calculating at least one feature value of each candidate in the second plurality of abnormality candidates; and
applying the at least feature value of each candidate to a classifier performing linear discriminant analysis on the calculated at least one feature value.

17. The method of claim 16, wherein the at least one feature value includes an average voxel value, a relative standard deviation of voxel value, a relative standard deviation of a distance between a centroid and a surface, and a difference between a maximum and a minimum distance between the centroid and the surface.

18. A computer program product configured to store plural computer program instructions which, when executed by a computer, cause the computer perform a method including the following steps:
obtaining volume image data corresponding to the at least one medical image;
filtering said volume image data using an enhancement filter to produce a filtered image in which a predetermined pattern is enhanced;
detecting, in said filtered image, a first plurality of abnormality candidates using multiple gray-level thresholding;
grouping, based on size and local structures, the first plurality of abnormality candidates into a plurality of abnormality classes;
removing false positive candidates from each abnormality class based on class-specific image features to produce a second plurality of abnormality candidates; and
applying the second plurality of abnormality candidates to a classifier and classifying each candidate in the second plurality of abnormality candidates as a false positive candidate or an abnormality.

19. The computer program product of claim 18, wherein the obtaining step comprises:
obtaining three-dimensional magnetic resonance angiography (MRA) volume image data.

20. The computer program product of claim 19, wherein the obtaining step comprises:
obtaining a plurality of axial MRA images; and
processing said plurality of axial MRA images to obtain isotropic volume image data, including at least one of interpolating and cropping of said plurality of axial MRA images.

21. The computer program product of claim 18, wherein said filtering step comprises:
using a geometric enhancement filter to produce a filtered image in which a geometric pattern is enhanced.

22. The computer program product of claim 18, wherein said filtering step comprises:
using a dot enhancement filter to produce a filtered image in which dot-like objects are enhanced.

23. The computer program product of claim 18, wherein said method further comprises:
identifying, in said filtered image, a search region corresponding to anatomy associated with the at least one abnormality,
wherein said detecting step comprises detecting said first plurality of abnormality candidates in said search region.

24. The computer program product of claim 23, wherein the identifying step comprises:
segmenting major vessels in said filtered image; and
dilating the segmented major vessels in said filtered image using a morphological filter having a circular kernel.

25. The computer program product of claim 23, wherein the identifying step comprises:
identifying a search region including a blood vessel associated with aneurysms.

26. The computer program product of claim 18, wherein the detecting step comprises:
forming a pixel-value histogram in a search area of said filtered image;
selecting a threshold value based on said pixel-value histogram;
identifying islands in said filtered image having pixel values greater than the selected threshold;
determining an effective diameter of each island;
selecting islands having an effective diameter greater than a predetermined diameter to be in the first plurality of abnormality candidates; and
segmenting each of the first plurality of abnormality candidates by performing region-growing based on at least one image feature.

27. The computer program product of claim 18, wherein the grouping step comprises:
calculating an effective diameter of each of the first plurality of abnormality candidates; and
grouping the first plurality of abnormality candidates into a large abnormality class and a small abnormality class based on the calculated effective diameter of each of the first plurality of abnormality candidates.

28. The computer program product of claim 27, wherein said method further comprises:
determining a skeleton image of each abnormality in the small abnormality class; and
partitioning the candidate abnormalities in the small abnormality class into at least two abnormality classes based on the determined skeleton images.

29. The computer program product of claim 28, wherein the partitioning step comprises:
grouping the candidate abnormalities in the small abnormality class into a short-branch type abnormality class, a single-vessel type abnormality class, and a bifurcation type abnormality class based on the determined skeleton images.

30. The computer program product of claim 29, wherein the removing step comprises:
calculating, based on the volume image data for each candidate abnormality in the short-branch type abnormality class, the single-vessel type abnormality class, and the bifurcation type abnormality class, at least one morphological feature including sphericity, a relative standard deviation of a distance between a centroid and a surface, and a maximum and a minimum distance between the centroid and the surface; and
removing the false positive candidates from the short-branch type abnormality class, the single-vessel type abnormality class, and the bifurcation type abnormality class based on the calculated morphological image features.

31. The computer program product of claim 18, wherein the removing step comprises:
calculating the class-specific image features for each abnormality in each of the plurality of abnormality classes; and
removing the false positive candidates from each abnormality class based on the calculated class-specific image features.

32. The computer program product of claim 31, wherein the class-specific image features include at least one of average voxel value, a relative standard deviation in voxel value, a relative contrast, an average contrast, effective diameter, sphericity, a relative standard deviation of a distance between a centroid and a surface, and a maximum and a minimum distance between the centroid and the surface.

33. The computer program product of claim 18, wherein the applying and classifying step comprises:
calculating at least one feature value of each candidate in the second plurality of abnormality candidates; and
applying the at least one feature value of each candidate to a classifier performing linear discriminant analysis on the calculated at least one feature value.

34. The computer program product of claim 33, wherein the at least one feature value includes an average voxel value, a relative standard deviation of voxel value, a relative standard deviation of a distance between a centroid and a surface, and a difference between a maximum and a minimum distance between the centroid and the surface.

35. A system configured to detect at least one abnormality in at least one medical image, comprising:
a mechanism configured to obtain volume image data corresponding to the at least one medical image;
a mechanism configured to filter said volume image data using an enhancement filter to produce a filtered image in which a predetermined pattern is enhanced;
a mechanism configured to detect, in said filtered image, a first plurality of abnormality candidates using multiple gray-level thresholding;
a mechanism configured to group, based on size and local structures, the first plurality of abnormality candidates into a plurality of abnormality classes;
a mechanism configured to remove false positive candidates from each abnormality class based on class-specific image features to produce a second plurality of abnormality candidates; and
a mechanism configured to apply the second plurality of abnormality candidates to a classifier and to classify each candidate in the second plurality of abnormality candidates as a false positive candidate or an abnormality.
